(19) United States
(12) Patent Application Publication
(10) Pub. No.: US 2014/0207275 A1
(43) Pub. Date: Jul. 24, 2014

(54) ELECTRIC HAND HAVING FORCE SENSOR

(71) Applicant: FANUC CORPORATION, MINAMITSURU-GUN (JP)

(72) Inventor: Tetsuro Sakano, Minamitsuru-Gun (JP)

(73) Assignee: FANUC CORPORATION, MINAMITSURU-GUN (JP)

(21) Appl. No.: 14/162,231

(22) Filed: Jan. 23, 2014

(30) Foreign Application Priority Data
Jan. 24, 2013 (JP) 2013-011197

(51) Int. Cl. B25J 15/00

(52) U.S. Cl. CPC B25J 15/00
USPC 700/213

(57) ABSTRACT

An electric hand for grasping an object by opening and closing fingers includes a force sensor for detecting forces acting on the fingers. The fingers are actuated based on a detected force value detected by the force sensor. When it is judged that the detected force value has reached a predetermined target force value, an electric current supplied to an actuating section is restricted so as not to be greater than a predetermined holding electric current.

### BACKGROUND OF THE INVENTION

1. Field of the Invention

The present invention relates to an electric hand for grasping an object with fingers.

2. Description of the Related Art

A Robot is used for successively conveying a large number of objects to predetermined positions. In general, a robot is provided with a hand having a plurality of fingers at an arm end thereof, and is operated to open and close the fingers to grasp an object. If a force for grasping the object is excessively strong, the object may be deformed or damaged. On the other hand, if the grasping force is excessively weak, the robot possibly fails to hold the object in the course of conveyance, possibly dropping the object. Therefore, it is necessary for the robot to have a grasping force which can be adjusted, dependent on hardness and weight of the object.

In the case of an electric hand driven by an electric motor, the fingers can be provided with a grasping force as necessary by adjusting a torque output from the electric motor. However, in order to provide the fingers with a sufficiently strong grasping force, it is necessary to supply a large electric current to the electric motor. If a large electric current is continuously supplied to the electric motor while the hand is grasping an object, operational efficiency of the electric motor may be lowered due to heat generated from the electric motor. Further, if the electric power supply is shut off due to power failure, there is a risk of the grasping force being lost, and as a result, the object held may fall.

JP-A-2011-183513 discloses an electric hand in which an electric current supplied to the electric motor is reduced after an object is held. According to this electric hand, it is intended to maintain a required grasping force even with the decreased electric current supplied to the electric motor, with the aid of hysteresis of a speed reducer provided between the electric motor and the fingers.

JP-A-2010-105125 discloses an electric hand provided with a spring. According to this electric hand, it is intended to maintain a grasping force even at the time of electric power failure with the aid of a biasing force by the spring.

In the electric hand disclosed in JP-A-2011-183513, it is necessary to ensure somewhat strong friction acting on the speed reducer. However, such friction causes an output torque generated by the electric motor in operation to be decreased, and therefore a grasping force provided to the fingers may be changed under influence of the friction. This makes it difficult to carry out precise control of the hand, and in the case where only a small grasping force is required, it is difficult to provide the fingers with an intended grasping force.

In the electric hand disclosed in JP-A-2010-105125, providing the spring results in the complicated structure of the electric hand, thereby increasing the cost. Further since the spring acts as a load of the electric motor, a greater torque or a larger electric current is required to operate the electric motor, and therefore heat generation from the electric motor may be problematic.

Thus, there is a need for an electric hand which allows a grasping force to be provided accurately and stably as necessary.

### SUMMARY OF THE INVENTION

According to a first aspect of the present application, an electric hand comprising a plurality of fingers for grasping an object when the fingers are opened and closed is provided. The electric hand further comprises: an actuating section for actuating the plurality of fingers; a force sensor associated with at least one of the plurality of fingers and adapted to detect a force acting on the at least one of the plurality of fingers in a direction of the actuation; a force control section for outputting a drive command based on a detected force value detected by the force sensor; a drive section for driving the actuating section by supplying an electric current to the actuating section, based on the drive command output from the force control section; a force judging section for judging whether or not the detected force value has reached a predetermined target force value; and an electric current restricting section for restricting the electric current supplied to the actuating section so as not to be greater than a predetermined holding electric current when it is judged by the force judging section that the detected force value has reached the target force value.

According to a second aspect of the present application, the electric hand according to the first aspect further comprises: a dead zone judging section for judging whether or not the detected force value is within a dead zone defined between an upper limit value greater than the target force value, and a lower limit value smaller than the target force value; and a restriction releasing section for releasing a restriction applied by the electric current restriction section on the electric current which is supplied to the actuating section, when it is judged by the dead zone judging section that the force detecting value is not within the dead zone.

According to a third aspect of the present application, in the electric hand according to the first or second aspect, the actuating section comprises an electric motor and a conversion mechanism for converting rotary motion of the electric motor into linear motion.

According to a fourth aspect of the present application, in the electric hand according to the third aspect, the conversion mechanism is a sliding screw.

These and other objects, features and advantages of the present invention will become more apparent in light of the detailed description of exemplary embodiments thereof as illustrated by the drawings.

### BRIEF DESCRIPTION OF THE DRAWINGS

FIG. 1 is a perspective view illustrating an electric hand.

FIG. 2 is a sectional view illustrating the interior structure of the electric hand.

FIG. 3 is a functional block diagram showing a control device for controlling the electric hand.

FIG. 4 is a flowchart showing a process for controlling the electric hand.

### DETAILED DESCRIPTION OF THE INVENTION

With reference to the accompanying drawings, embodiments of the present invention will be described. Constituent elements of the illustrated embodiments may be modified in size in relation to one another for better understanding of the present invention.

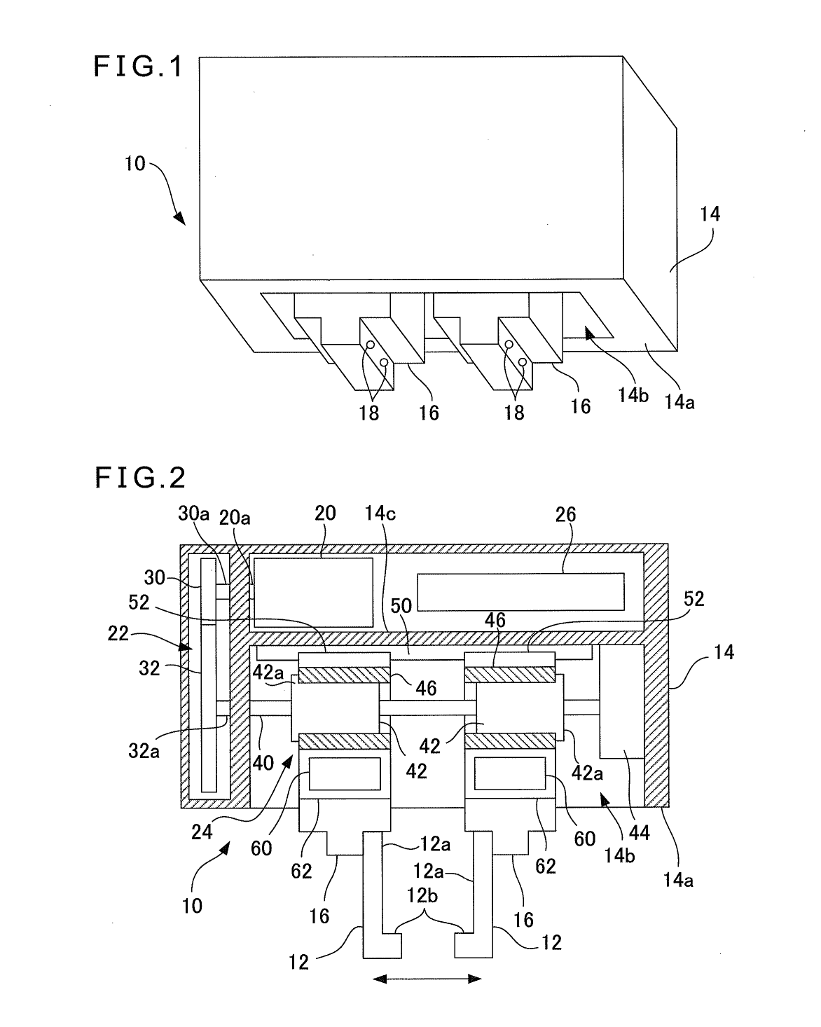

FIG. 1 is a perspective view illustrating an electric hand 10, which will be hereinafter referred to as “hand.” FIG. 2 is a sectional view illustrating the interior structure of the hand 10. In FIG. 1, fingers 12 of the hand 10 are omitted. In order to attach the fingers 12 to the hand 10, the fingers 12 are respectively fixed to a pair of finger bases 16 which extend downward from a bottom face 14a of a casing 14 of the hand 10. FIG. 1 shows threaded holes 18 through which fixing screws (not shown) for fixing the fingers 12 are inserted. The pair of finger bases 16 are provided so as to be linearly movable in the opposite directions within the interior 14b defined by the casing 14.

As shown in FIG. 2, the respective fingers 12 have a substantially L-shape in front view. The fingers 12 include a finger body 12a fixed to the finger base 16, and a gasping section 12b protruding toward the other of the fingers 12 facing each other. The fingers are made of elastic material, such as stainless steel and iron. As further described below, the pair of fingers 12 are moved in the directions shown by arrows together with the finger base 16 so that a gap therebetween can be narrower or wider. These fingers 12 are actuated in the opposite directions to open and close the grasping sections 12b thereof. The hand 10 is designed to grasp an object between the grasping sections 12b of the fingers 12 or release the object therefrom by opening and closing the grasping sections 12b. The shapes of the hand 10 and the finger 12 are shown in the drawings by way of example. Therefore, the hand and the finger may have any shape as necessary. The arrangement, configuration and number of the fingers may also vary as necessary.

The hand 10 includes an electric motor 20, a transmission mechanism 22 for transmitting an output torque of the electric motor 20, a conversion mechanism 24 for converting rotary motion of the transmission mechanism 22 into linear motion, and a control device 26 for controlling operation of the electric motor 20. The control device 26 includes hardware components such as CPU, ROM and RAM, which are not shown in the drawings. A ROM is a non-volatile memory in which a control program for operating the electric motor 20 to grasp an object is stored and related data such as various parameters are also stored. A CPU implements various computations for carrying out the control program stored in the ROM. A RAM is a volatile memory for temporarily storing the result of the computations implemented by the CPU. The control device 26 and the electric motor 20 are connected to each other by a cable, which is not shown in the drawing. A control electric current is supplied through this cable in order to drive the electric motor 20.

The transmission mechanism 22 includes a first rotary element 30 and a second rotary element 32 which cooperate with each other to transmit power. A rotary axis 30a of the first rotary element 30 is coupled to the rotary axis 20a of the electric motor 20. The electric motor 20 and the first rotary element 30 are rotated at the same speed. The second rotary element 32 is configured to transmit rotary power of the first rotary element 30 at a predetermined speed reduction ratio. As described above, the transmission mechanism 22 functions as a speed reducer to increase and transmit a torque output from the electric motor 20.

The transmission mechanism 22 may be formed from a gear, a timing belt, a pulley or other known transmission mechanism. Alternatively, the transmission mechanism 22 may not function as a speed reducer. In this case, a speed reducer is provided separately from the transmission mechanism 22.

The rotary motion of the output axis 32a of the second rotary element 32 is converted into linear motion by the conversion mechanism 24. The conversion mechanism 24 includes a feed screw 40 coupled to the output axis 32a of the second rotary element 32, a pair of nuts 42 screwed to the feed screw 40, and a bearing 44 for rotatably supporting the feed screw 40. The feed screw 40 includes a right hand threaded portion in which a right hand thread is formed, and a left hand threaded portion in which a left handed thread is formed. The right hand threaded portion and the left hand threaded portion extend in opposite directions from the central portion, respectively. One of the pair of nuts 42 is screwed to the right hand threaded portion and the other nut 42 is screwed to the left hand threaded portion. According to this arrangement, the pair of nuts 42 are moved in the opposite directions so as to move closer to or away from each other, as the feed screw 40 is rotated. The feed screw 40 may be a ball screw or a sliding screw.

The nut 42 is mounted on a nut mounting section 46. In FIG. 2, the nut mounting section 46 is shown with hatching. The nut mounting section 46 is provided with a concentric through-hole. The nut mounting section 46 is configured to receive the nut 42 in this through-hole. The nut 42 includes on an end face thereof a flange 42a protruding radially outwardly. The flange 42a and the nut mounting section 46 are fixed to each other by a bolt (not shown).

The conversion mechanism 24 further includes a slider guide section 50 mounted on an actuating section wall 14c which partitions the interior 14b of the casing 14, and a slider 52 fitted to the slider guide section 50 so as to be linearly slidable therealong. The nut mounting section 46 is bolted to the slider 52 such that as the feed screw 40 is rotated, the nut 42 can linearly move along the slider guide section 50 without rotating around the feed screw 40. For example, the slider guide section 50 is provided with a groove extending over an entire length thereof. For example, the slider 52 has a protrusion adapted to be fitted to the groove of the slider guide section 50.

The finger base 16 capable of receiving the finger 12 is fixed to the nut mounting section 46 with a sensor housing 62 interposed therebetween. A force sensor 60 is accommodated in the sensor housing 62. According to the transmission mechanism 22 and the conversion mechanism 24 configured in the above-described manner, when the feed screw 40 is rotated in response to the electric motor 20 in motion, the nut 42, the nut mounting section 46, the slider 52, the sensor housing 62, the finger base 16 and the finger 12 move together linearly along the slider guide section 50. As described above, the electric motor 20, the transmission mechanism 22 and the conversion mechanism 24 cooperate with one another to function as an actuating section for actuating the fingers 12 of the hand 10.

The force sensor 60 is provided on the base end side of the finger base 16 to detect force acting in the actuating direction of the finger 12. In the illustrated embodiment, the force sensor 60 is provided for each of the pair of fingers 12. However, the force sensor 60 may be provided for only one of the fingers 12. Since forces acting on the respective fingers 12 to grasp an object are equal to each other, but act in opposite directions due to an action-reaction relationship, it is only necessary to detect force acting on one of the fingers 12.

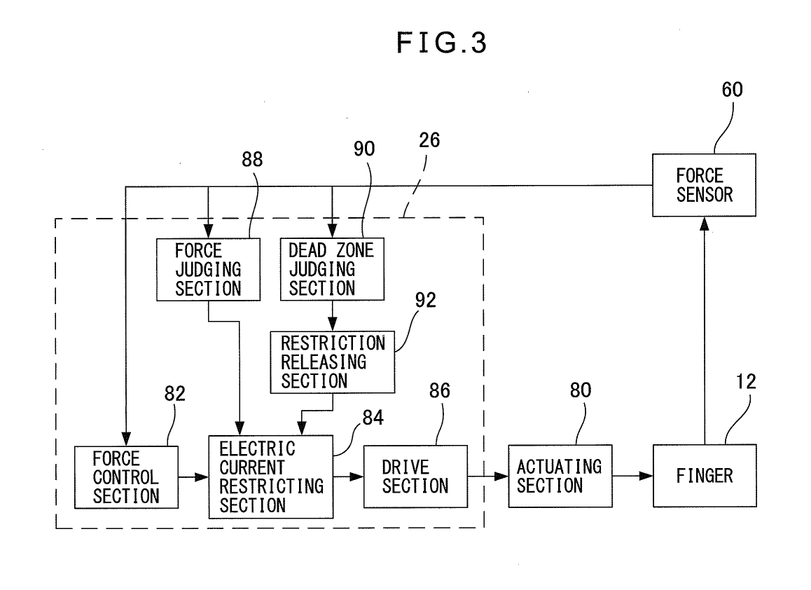

Next, the configuration of the control device 26 of the hand 10 will be described. FIG. 3 is a block diagram of the control device 26 for controlling the hand 10. The actuating section 80 includes a transmission mechanism 22 and a conversion mechanism 24 as described above with reference to FIG. 2 to open and close the fingers 12. The fingers 12 are actuated by the actuating section 80 to grasp an object. The force sensor 60 obtains forces acting on the fingers in the actuating directions of the fingers, i.e., forces for grasping an object as a detected force value. The control device 26 includes a force control section 82, an electric current restricting section 84, a drive section 86, a force judging section 88, a dead zone judging section 90, and a restriction releasing section 92.

The force judging section 88 judges whether or not the detected force value output from the force sensor 60 has reached a target force value. Judgment by the force judging section 88 may be based on whether or not the detected force value exceeds the target force value, or whether or not the detected force value is within a target force range which is defined by an allowable range from several per cent to about 10 per cent of the target force value. The dead zone judgment section 90 judges whether or not the detected force value is within a range of a dead zone. The dead zone is defined by a range between an upper limit value greater than the target force value, and a lower limit value smaller than the target force value.

The force control section 82 carries out feedback control such that the detected force value output from the force sensor 60 matches a predetermined target force value. The force control section 82 outputs a drive command to the electric current restricting section 84, based on an amount of force deviation between the detected force value and the target force value. The electric current restricting section 84 is designed to restrict an electric current so that the drive command output from the force control section 82 is not greater than a predetermined holding electric current. Once it is judged by the force judgment section 88 that the detected force value has reached the target force value, the electric current restricting section 84 is activated and continues its operation until grasping operation is completed. The electric current restricting section 84 is designed to output a drive command from the force control section 82 as is, until it is judged by the force judgment section 88 that the detected force value has reached the target force value.

The drive section 86 supplies an electric current to drive the electric motor 20 of the actuating section 80, in response to a drive command input from the force control section 82 through the electric current restricting section 84. The electric current supplied to the electric motor 20 is an electric current corresponding to the drive command from the force control section 82 as described above, or an electric current restricted by the electric current restricting section 84 so as not to be greater than the holding electric current.

When the dead zone judgment section 90 judges that the detected force value is not within a range of the dead zone, the restriction release section 92 outputs a release signal to the electric current restricting section 84 to terminate the electric current restriction applied by the electric current restricting section 84. Accordingly, once the electric current restricting section 84 is activated, the electric current continues to be restricted until the grasping motion is completed, or until a release signal is output from the restriction release section 92.

An exemplary case under the following condition will be described:

Target force value: 10 [N];

Holding electric current: 2 [A];

Target force range: 5% of the target force value (i.e., 9.5 to 10.5 [N]);

Dead zone: 10% of the target force value (i.e., 9 to 11 [N]).

In this case, when the detected force value detected by the force sensor 60 is included in the target force range from 9.5 to 10.5 [N], the force judgment section 88 judges that the detected force value has reached the target force value. Further, when the detected force value is included in the range from 9 to 11 [N], the dead zone judgment section 90 judges that the detected force value is within a range of the dead zone. When it is judged that the detected force value is within a range of the dead zone, an electric current supplied to the electric motor 20 of the actuating section 80 is restricted so as not to be greater than the holding electric current of 2 [A] by means of the electric current restricting section 84. In other words, in the case where an electric current corresponding to the drive command generated by the force control section 82 exceeds an upper limit of 2 [A], the electric current supplied will be restricted to 2 [A] by the electric current restricting section 84.

In the above-described example, a range of the dead zone is set to be wider than the target force range.

According to this setting, operation of the hand 10 becomes more stable. For example, in the case where the dead zone and the target force range are set to the same range, when a detected force value deviates even slightly from the target force range, the electric current restriction will be immediately released. This may cause the electric current restricting section 84 to be unnecessarily repeatedly activated and deactivated. However, setting values such as a holding electric current, a target force value, a range of dead zone and a target force range should be set as necessary, and therefore the scope of the present invention should not be limited by any of these setting values.

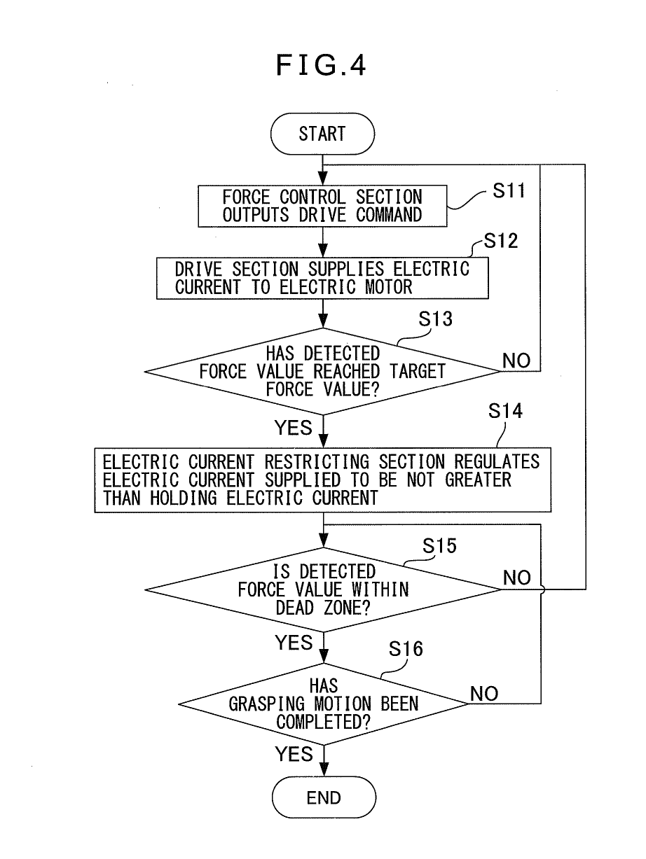

Referring to FIG. 4, operation of the hand 10 will be described. FIG. 4 is a flowchart showing a process of controlling the hand 10. When grasping operation begins, the force control section 82 outputs a drive command (step S11). The force control section 82 is configured to generate a drive command based on an amount of force deviation between a detected force value output from the force sensor 60 and a target force value. It should be noted that the detected force value output from the force sensor 60 is zero at the beginning of the grasping operation. Accordingly, at the beginning of the grasping operation, a predetermined initial value of the drive command may be output, for example, instead of one generated as a result of regular feedback control.

The drive section 86 supplies, in response to the drive command from the force control section 82, an electric current whose intensity corresponds to the drive command to the electric motor 20 of the actuating section 80 (step S12). The actuating section 80 utilizes the power of the electric motor 20 through the transmission mechanism 22 and the conversion mechanism 24, so as to move a pair of fingers 12 closer to each other. After an object is grasped by the fingers 12, a grasping force applied to the fingers 12 can be increased by further movement of the fingers 12.

Steps S11 and S12 are repeated until it is judged at step S13 by the force judgment section 88 that the detected force value has reached the target force value. The target force value is determined based on materials of which the fingers 12 and the object are made or other conditions, so as to allow the object to be stably held without excessive deformation of the object.

At step S13, when it is judged that the detected force value has reached the target force value, the electric current restricting section 84 is activated and the electric current is restricted as necessary to ensure that the drive command output by the force control section 82 does not exceed a predetermined holding electric current (step S14). Specifically, in the case where a drive command exceeding the holding electric current is generated, the holding electric current is supplied to the electric motor 20, instead of the electric current corresponding to the drive command.

In this embodiment, even after the electric current supplied to the electric motor 20 is decreased, a required grasping force can be maintained by with the aid of friction generated in the transmission mechanism 22 and the conversion mechanism 24. For example, friction forces generated in the speed reducer mechanism of the transmission mechanism 22 and in the feed screw 40 and the nut 42 of the conversion mechanism 24 are used as braking of the actuating section 80. The fingers 12 bear forces acting in directions that move the fingers 12 away from each other due to the counteraction from the object. However, due to the braking action of the friction forces, the electric motor 20 is not rotated unless a very large force is applied to the fingers 12. Therefore, even when the electric current supplied to the electric motor 20 is restricted, the grasping force can be maintained. In the case where the feed screw 40 is a sliding screw, a contact area with the nut 42 is large and therefore, a relatively larger friction force is generated. In such a case, the holding electric current can be advantageously set to a lower value.

In this way, once the fingers 12 grasp the object with a sufficiently strong force as described above, the electric current supplied to the electric motor 20 can be decreased, and therefore, excessive heat generation from the electric motor 20 can be prevented. In order to increase the braking action by the friction force, the speed reduction ratio of the transmission mechanism 22 may be increased. Alternatively, the lead of the feed screw 40, or in other words, a moving distance per one rotation may be decreased. A combination of these may also be implemented. As long as a sufficiently strong braking effect is ensured, even in the case where electric power supplied to the electric motor 20 is temporarily completely shut off, e.g., in the case of electric power failure, the grasping force applied by the finger 12 can be maintained.

While the electric current restricting section 84 is in operation, the dead zone judgment section 90 judges in each control cycle whether or not the detected force value is within the dead zone (step S15). When it is judged at step S15 that the detected force value deviates from the dead zone, the process returns to step S11 and the regular feedback control is carried out without the electric current restriction by the electric current restricting section 84. In this way, according to the hand 10 of the present embodiment, after a sufficiently strong grasping force is applied to the fingers 12 and the electric current supplied to the electric motor 20 is reduced and when the grasping force is decreased for some reasons, the process returns to the regular control in which the grasping force can be maintained. For example, the decreased grasping force may result from an unexpected deformation of the object, which makes it difficult to maintain the grasping force. The judging process by the dead zone judging section 90 continues until the grasping operation is completed (step S16).

As described above, according to the hand of this embodiment, it is possible to accurately apply various degrees of grasping forces as necessary, depending on given conditions, through the feedback control using the detected force value obtained from the force sensor associated with the fingers. After the required grasping force has been achieved, the electric current supplied to the electric motor is restricted. Therefore, even in the case where the object is grasped for a long period of time, it is possible to prevent excessive heat generation from the electric motor. This advantageously allows for use of a compact electric motor and eliminates a need for an expensive heat releasing means. With a downsized electric motor, it is also possible to make the entire size of the hand smaller, thereby reducing the cost, and expanding possible application thereof. If a sliding screw is used as the conversion mechanism, a holding electric current for maintaining the grasping force can be lowered. Therefore, even at the time of electric power failure, it is possible to prevent the object from falling off the hand due to loss of the grasping force applied by fingers. In addition, even in the case where the grasping force is unexpectedly decreased after the electric current restriction comes into play, the process may return to the regular control, thereby increasing reliability of the grasping operation.

The above-described dead zone judging section 90 and restriction releasing section 92 may be omitted. For example, in the case where an object has enough rigidity that it is not deformed by a usual grasping operation, once a required grasping force is achieved, it is not necessary to release the electric current restriction until the grasping operation is completed. In such a case, the functions of the control device 26 can be simplified with omission of the dead zone judging section 90 and the restriction releasing section 92.

Immediately after the object is grasped, the grasping force may be unstable as a result of overshooting of the electric motor 20. Therefore, the force judgment section 88 may be configured to carry out its judging process after a predetermined period of time, e.g., 10 ms, from the start of the grasping operation.

In the case where a reduction ratio of the speed reducer mechanism used in the actuating section is large or in the case where a lead of the feed screw is small, motions of the fingers may be locked by the friction even when an electric current supplied to the actuating section is shut off. In this case, the holding electric current applied by the electric current restricting section may be set to zero, or in other words, the electric current supplied to the actuating section may be completely shut off.

### EFFECTS OF THE INVENTION

According to the electric motor having the above-. described configuration, forces acting on the fingers are detected by the force sensor, and then the grasping force is adjusted based on the result of the detection. This makes it possible to accurately provide the fingers with grasping forces as necessary, over a wide range of degrees of grasping force from a large force to a small force.

Although the embodiments of the present invention have been explained above, it is obvious for a person skilled in the art that the intended operation and effect of the present invention may also be achieved by other embodiments and variations. In particular, the components of the embodiments described above may be deleted or substituted with others, or a known means may be added thereto, without departing from the scope of the present invention. It is also obvious for a person skilled in the art that the present invention may also be implemented in a combination of any features in a plurality of embodiments explicitly or implicitly disclosed herein.

What is claimed is:

1. An electric hand comprising a plurality of fingers for grasping an object when the fingers are opened and closed,
the electric hand further comprising:
an actuating section for actuating the plurality of fingers;
a force sensor associated with at least one of the plurality of fingers and adapted to detect a force acting on the at least one of the plurality of fingers in a direction of the actuation;
a force control section for outputting a drive command based on a detected force value detected by the force sensor;
a drive section for driving the actuating section by supplying an electric current to the actuating section, based on the drive command output from the force control section;
a force judging section for judging whether or not the detected force value has reached a predetermined target force value; and
an electric current restricting section for restricting the electric current supplied to the actuating section so as not to be greater than a predetermined holding electric current when it is judged by the force judging section that the detected force value has reached the target force value.

2. The electric hand according to claim 1, further comprising:
a dead zone judging section for judging whether or not the detected force value is within a dead zone defined between an upper limit value greater than the target force value, and a lower limit value smaller than the target force value; and
a restriction releasing section for releasing a restriction applied by the electric current restriction section on the electric current which is supplied to the actuating section, when it is judged by the dead zone judging section that the force detecting value is not within the dead zone.

3. The electric hand according to claim 1, wherein the actuating section comprises an electric motor and a conversion mechanism for converting rotary motion of the electric motor into linear motion.

4. The electric hand according to claim 3, wherein the conversion mechanism is a sliding screw.
